(19) United States
(12) Patent Application Publication
(10) Pub. No.: US 2011/0305419 A1
(43) Pub. Date: Dec. 15, 2011

(54) CONNECTOR ASSEMBLY HAVING GUIDING DEVICE FOR ALIGNING OPTIC MODULE

(75) Inventor: RICHARD SCOTT KLINE, Mechanicsburg, PA (US)

(73) Assignee: HON HAI PRECISION INDUSTRY CO., LTD., Tu-Cheng (TW)

(21) Appl. No.: 12/797,638

(22) Filed: Jun. 10, 2010

(51) Int. Cl. G02B 6/38

(52) U.S. Cl. 385/74

(57) ABSTRACT

A connector assembly (100) includes an insulative housing (2) defining a mounting cavity (221) and two guiding grooves (2216) located in the mounting cavity, the two guiding grooves spaced apart from each other along a transversal direction; an optical module (5) accommodated in the mounting cavity, said optical module (5) having at least one lens (51) and a holder (52) enclosing the at least one lens, two ribs (521) formed on a bottom surface of the holder and received in the two guiding grooves, respectively; and an elastic member (9) sandwiched between the optical module and the insulative housing so as to urge the optical module forwardly moving in the mounting cavity.

### CROSS-REFERENCE TO RELATED APPLICATIONS

This application is related to U.S. patent application Ser. No. 12/626,631, filed on Nov. 26, 2009 and entitled “CABLE ASSEMBLY HAVING POSITIONING MEANS SECURING FIBER”, which has the same assignee as the present invention.

### BACKGROUND OF THE INVENTION

1. Field of the Invention

The present invention relates to a connector assembly, more particularly to a connector assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connectors and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a kind of connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to be floatable with regard to the housing. They are not accurately aligned with, and optically coupled to counterparts, if there are some errors in manufacturing process.

### BRIEF SUMMARY OF THE INVENTION

Accordingly, an object of the present invention is to provide a connector assembly has positioning means for securing fibers thereof.

In order to achieve the above-mentioned object, a connector assembly in accordance with present invention comprises an insulative housing defining a mounting cavity and two guiding grooves located in the mounting cavity, the two guiding grooves spaced apart from each other along a transversal direction; an optical module accommodated in the mounting cavity, said optical module having at least one lens and a holder enclosing the at least one lens, two ribs formed on a bottom surface of the holder and received in the two guiding grooves, respectively; and an elastic member sandwiched between the optical module and the insulative housing so as to urge the optical module forwardly moving in the mounting cavity.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a connector assembly in accordance with the present invention;

FIG. 2 is an exploded, perspective view of FIG. 1;

FIG. 3 is similar to FIG. 2, but viewed from another aspect;

FIG. 4 is a partially assembled view of the connector assembly;

FIG. 5 is other partially assembly view of the connector assembly; and

FIG. 6 is a cross-section view of the connector assembly taken along line 6-6;

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

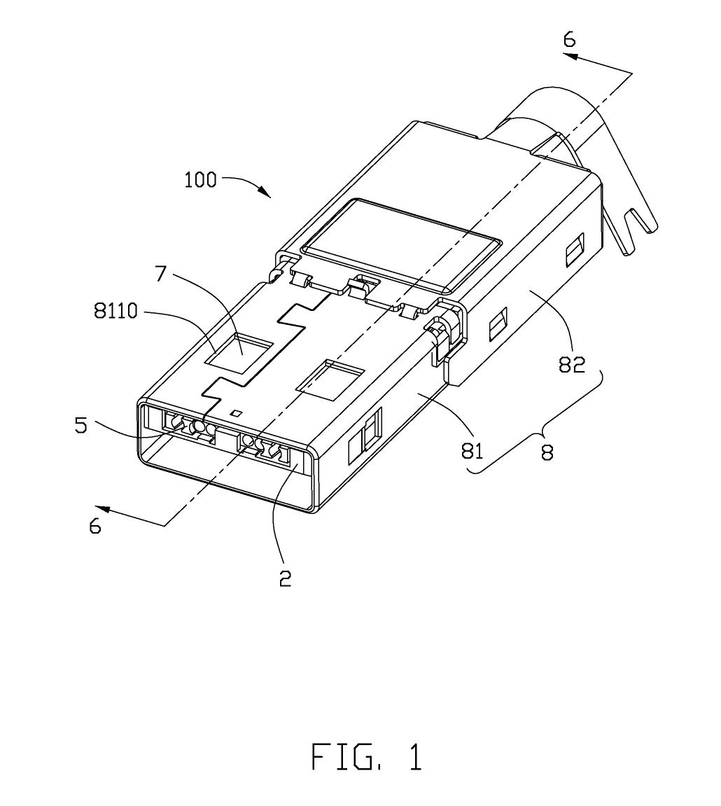

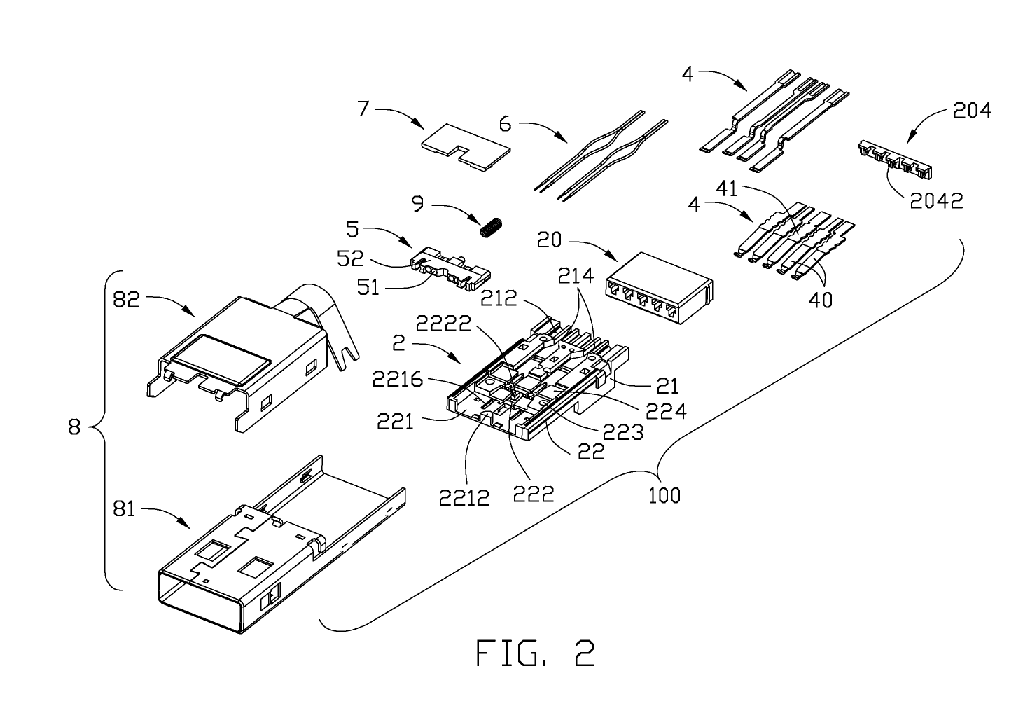

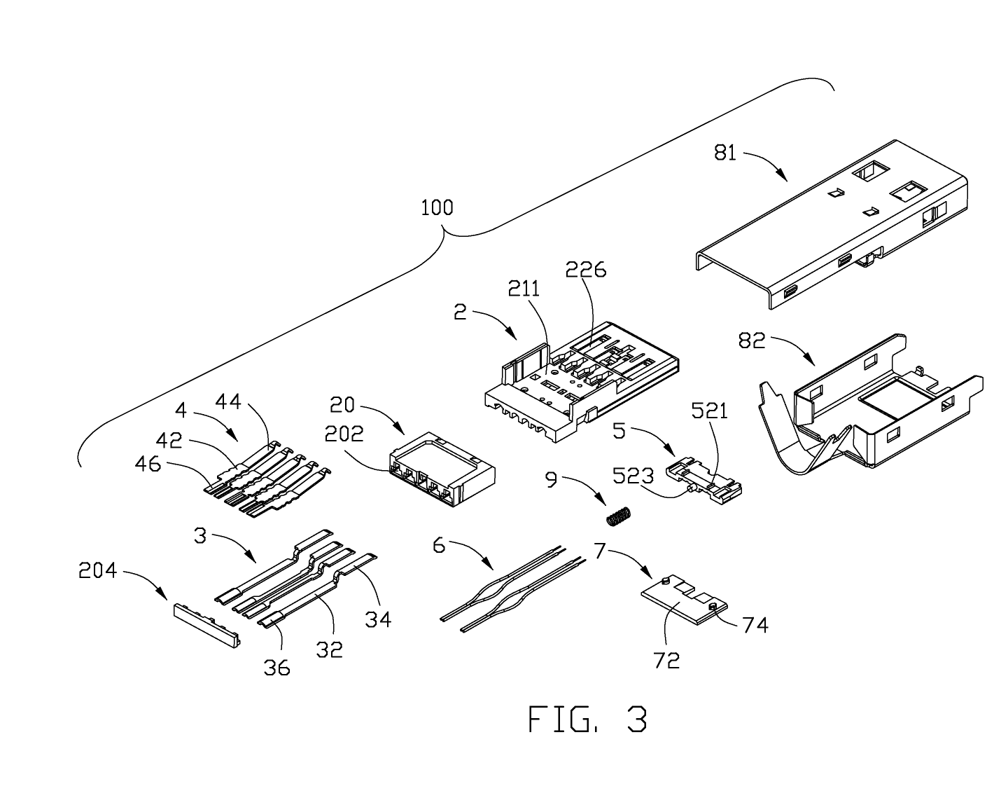

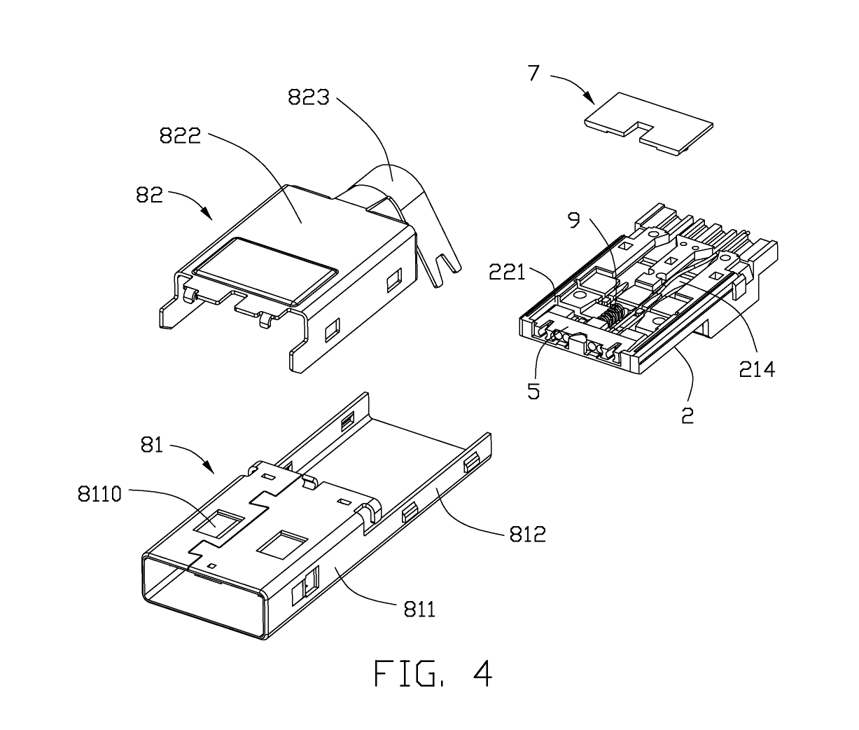

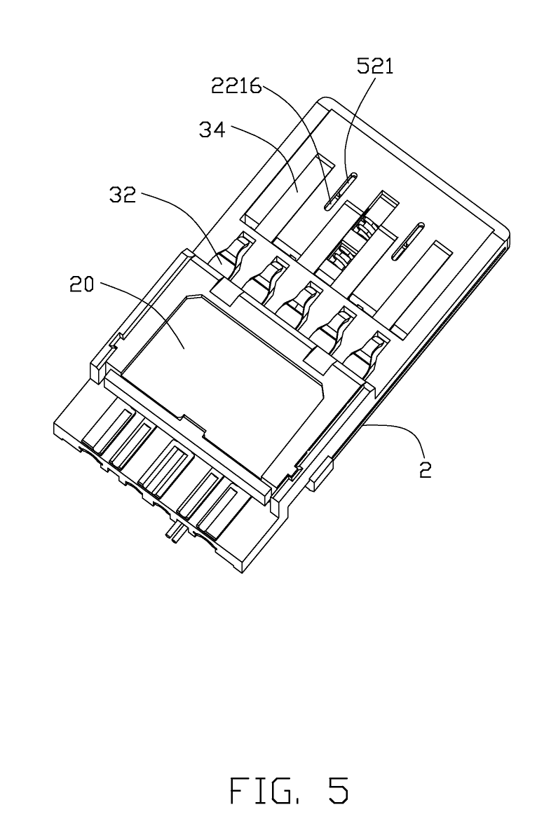

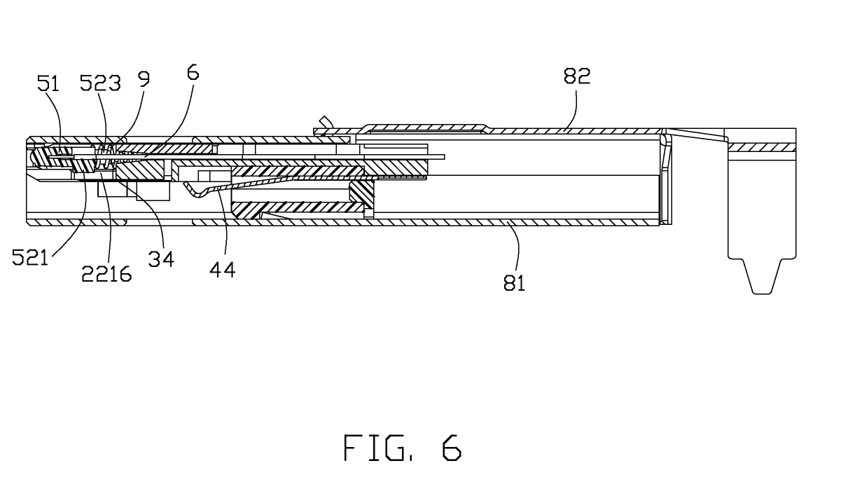

Referring to FIGS. 1-6, a connector assembly 100 according to the first embodiment of the present invention is disclosed. The connector assembly 100 comprises an insulative housing 2, a set of first contacts 3, a set of second contacts 4 and a optical modules 5 supported by the insulative housing 2, and a number of fibers 6 connected to the optical module 5. The connector assembly 1 further comprises a cap member 7, a metal shell 8 and an elastic member 9. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. A positioning slot 222 is defined in a rear portion mounting cavity 221. A positioning post 2222 is arranged in the positioning slot 222. A depression 224 is defined in the rear part of the tongue portion 22 and located behind the mounting cavity 221. The depression 224 is shallow than the mounting cavity 221. A number of contact slots 212 are defined in an upper segment of a rear portion of the base portion 21, and two fiber slots 214 are also defined in the upper segment of the rear portion of the base portion of the base portion 21. Two guiding grooves 2216 are located in the mounting cavity 221 and spaced apart from each other along a transversal direction.

The set of first contacts 3 has four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a corresponding passage 226 of the lower section of the front segment of the tongue portion 22, and a tail portion 36 extending rearward from the retention portion 32 and accommodated in the terminal slots 212.

The set of second contacts 4 has five contact members arranged in a row along the transversal direction and combined with an insulator 20. The set of second contacts 4 are separated into two pair of signal contacts 40 for transmitting differential signals and a grounding contact 41 disposed between the two pair of signal contacts 40. Each signal contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the corresponding mounting cavity 221. Two guiding ribs 521 are formed on a bottom surface of the holder member 52 and spaced apart from each other along a transversal direction. Each guiding rib 521 extends along a front-to-back direction. A cylindrical protrusion 523 is formed on a back surface of the holder member 52 and projects rearwardly. The protrusion 523 is located in a middle portion of an imaginary space which is formed between the two guiding ribs 521. The elastic member 9 is a coil spring and has a front segment and a back segment. The protrusion 523 is inserted into an interior of the front segment of the elastic member 9. The back segment of the elastic member 9 is accommodated in the positioning slot 222, with the positioning post 2222 extending into an interior of the back segment of the elastic member 9. Therefore, the elastic member 9 is sandwiched between the optical module 5 and the insulative housing 2 so as to constantly urge the optical module 5 forwardly moving within the mounting cavity 221. Also, the two guiding ribs 521 are received in the two guiding grooves 2216 and slide therein along a front-to-back direction. Therefore, the optical module 5 does not tilt when moving in the mounting cavity 221.

Four fibers 6 are separated into two groups and pass through the fiber slots 214, enter the two depressions 224 and are coupled to the four lens 51, respectively. The cap member 7 has a body portion 72 and two crushable posts 74 formed on a bottom surface thereof. The cap member 7 is assembled to the tongue portion 22, with body portion 72 accommodated in the depression 224 to cover and secure the fibers 6, and the crushable posts 74 are inserted into holes 223 in the depression 224.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8110 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the windows 811, and the base portion 21 is received in the body portion 812. The second shield part 82 is assembled to the first shield part 81, with body portions 822, 812 combined together. The connector assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

What is claimed is:

1. A connector assembly, comprising:
an insulative housing defining a mounting cavity and two guiding grooves located in the mounting cavity, the two guiding grooves spaced apart from each other along a transversal direction;
an optical module accommodated in the mounting cavity, said optical module having at least one lens and a holder enclosing the at least one lens, two ribs formed on a bottom surface of the holder and received in the two guiding grooves, respectively; and
an elastic member sandwiched between the optical module and the insulative housing so as to urge the optical module forwardly moving in the mounting cavity.

2. The connector assembly as claimed in claim 1, wherein the elastic member is a coil spring.

3. The connector assembly as claimed in claim 2, wherein there is a protrusion portion formed on a back surface of the holder of optical module and the protrusion portion is inserted into a front segment of the coil spring.

4. The connector assembly as claimed in claim 3, wherein the protrusion portion is located in a middle section of an imaginary space which is formed between the two guiding ribs.

5. The connector assembly as claimed in claim 3, wherein there is a positioning post located within a rear portion the mounting cavity, and the positioning post extends into a rear portion of the coil spring.

6. The connector assembly as claimed in claim 1, further comprising a plurality of contacts supported by the insulative housing.

7. The connector assembly as claimed in claim 6, wherein the contacts are divided into a set of first contacts and a set of second contacts.

8. A connector assembly, comprising:
an insulative housing having a front segment and a rear segment, a mounting cavity defined in the front segment of the housing and two guiding grooves located in the mounting cavity, the two guiding grooves spaced apart from each other along a transversal direction, two fiber slots defined in the rear portion of the insulative housing;
an optical module accommodated in the mounting cavity, said optical module having a plurality of lenses and a holder enclosing the lenses, two ribs formed on a bottom surface of the holder and capable of sliding in the two guiding grooves; and
a plurality of fibers separated into two groups, passing through the two fiber slots and connected to the lenses of the optical module.

9. The connector assembly as claimed in claim 8, further comprising a cap assembled to the insulative housing to cover the fiber.

10. The connector assembly as claimed in claim 8, further comprising a plurality of contacts supported by the insulative housing.

11. The connector assembly as claimed in claim 10, wherein the contacts are divided into a set of first contacts and a set of second contacts.

12. The connector assembly as claimed in claim 11, wherein mating portions of the first contacts are spaced apart from mating portions of the second contacts along a front-to-back direction.

13. The connector assembly as claimed in claim 12, wherein mating portions of the first and the second contacts and the optical module are disposed at opposite sides of the insulative housing.

14. The connector assembly as claimed in claim 9, further comprising a metal shell shielding the insulative housing.

15. The connector assembly as claimed in claim 14, wherein the metal shell defines two windows, and the cap member is arranged underneath the two windows.

16. A connector assembly comprising:
an insulative housing including a base portion and a tongue portion extending forwardly from the base portion with opposite first and second faces thereof in a vertical direction;
a mating face formed upon the first face of the tongue portion;
a plurality of contacts disposed in the housing with contacting sections exposed upon the mating face;
a mating cavity formed adjacent to the tongue portion and facing the first face for receiving a complementary connector; and
a mounting cavity formed in the second face of the tongue portion;
an optical module accommodated within the mounting cavity and moveable back and forth along a front-to-back direction perpendicular to the vertical direction, said optical module including a lens set forwardly communicating with an exterior via a front face of the tongue portion, and a fiber set rearwardly extending therefrom; wherein
a rib is formed on one of said the tongue portion and said optical module, and a guiding groove is formed in the other to receive said rib for guiding back-and-forth movement of said optical module in said front-to-back direction.

17. The connector assembly as claimed in claim 16, wherein said rib is formed on the optical module, and said guiding groove is formed in the tongue portion facing the mounting cavity.

18. The connector assembly as claimed in claim 17, wherein said guiding groove is located between the mating cavity and the mounting cavity in said vertical direction.

19. The connector assembly as claimed in claim 18, wherein said guiding groove communicates with the mating cavity in said vertical direction.

20. The connector assembly as claimed in claim 16, wherein said rib and said guiding groove are located between two adjacent contacting sections in a transverse direction perpendicular to both said vertical direction and said front-to-back direction.
